(19) United States
(12) Patent Application Publication
(10) Pub. No.: US 2015/0211901 A1
(43) Pub. Date: Jul. 30, 2015

(54) COVER ASSEMBLY

(71) Applicant: Solar Turbines Inc., San Diego, CA (US)

(72) Inventor: Sean M. Thomas, San Diego, CA (US)

(73) Assignee: Solar Turbines Inc., San Diego, CA (US)

(21) Appl. No.: 14/163,856

(22) Filed: Jan. 24, 2014

(51) Int. Cl. G01D 11/24

(52) U.S. Cl. CPC G01D 11/245

(57) ABSTRACT

A cover is provided for a sensor port. The cover includes an open end disposed proximal to the sensor port. The cover further includes a closed end disposed in opposing relation to the open end. The cover further includes a passage laterally defined between the open end and the closed end. The passage is disposed proximal to the open end and is configured to allow fluid communication of the sensor port with atmosphere.

### TECHNICAL FIELD

The present disclosure relates to a cover, and more particularly to a cover for a sensor port of a power system.

### BACKGROUND

Sensors are typically employed by power systems to measure conditions such as temperature, pressure, humidity, and the like. However, these sensors may be influenced to provide biased values of the conditions due to various reasons, for example, a change in the conditions occurring locally or in the vicinity of the power system. For example, a gust of wind occurring near an enclosure may bias a value of atmospheric pressure and hence, influence a pressure sensor, associated with the enclosure, to record a higher or lower value of atmospheric pressure.

In some cases, the biased values may lead to incorrect monitoring of the machine. In other cases, the biased values may indicate unfavorable operating conditions and cause complete shutdown of the machine. Therefore, measurements obtained from such sensors may sometimes be unreliable, and cause undesirable operational changes to a state of the machine.

### SUMMARY

In one aspect, the present disclosure discloses a cover for a sensor port. The cover includes an open end disposed proximal to the sensor port. The cover further includes a closed end disposed in opposing relation to the open end. The cover further includes a passage laterally defined between the open end and the closed end. The passage is disposed proximal to the open end and is configured to allow fluid communication of the sensor port with atmosphere.

In another aspect, the present disclosure discloses a power system. The power system includes a frame, and an enclosure disposed on the frame. The power system further includes an engine disposed within the enclosure. The power system further includes at least one pressure sensor disposed within the enclosure and associated with the engine. The power system further includes a sensor port. The sensor port is located on the frame and disposed in fluid communication with the at least one pressure sensor. The power system further includes a cover disposed on the sensor port. The cover defines a passage disposed laterally with respect to the sensor port. Further, the passage is located proximate to the sensor port and is configured to allow fluid communication of the sensor port with atmosphere.

In another aspect, the present disclosure provides a method of allowing fluid communication between a sensor port and atmosphere. The method includes positioning a cover on the sensor port, wherein the cover defines a passage located proximate to the sensor port and disposed laterally with respect to the sensor port. The method further includes directing air laterally from the passage to the sensor port.

Other features and aspects of this disclosure will be apparent from the following description and the accompanying drawings.

### BRIEF DESCRIPTION OF THE DRAWINGS

FIG. 1 is a breakaway perspective view of a power system, in accordance with an exemplary embodiment of the present disclosure;

FIG. 2 is a top cross sectional view of the exemplary power system showing an exemplary cover employed therein;

FIG. 3 is a perspective view of a base plate used in the exemplary cover of FIG. 2;

FIG. 4 is a perspective view of the exemplary cover of FIGS. 1-2, in accordance with an exemplary embodiment of the present disclosure;

FIG. 5 is a side cross sectional view of the exemplary cover of FIG. 1, in accordance with an exemplary embodiment of the present disclosure; and

FIG. 6 shows a method of allowing fluid communication between a sensor port of the power system and an atmosphere.

### DETAILED DESCRIPTION

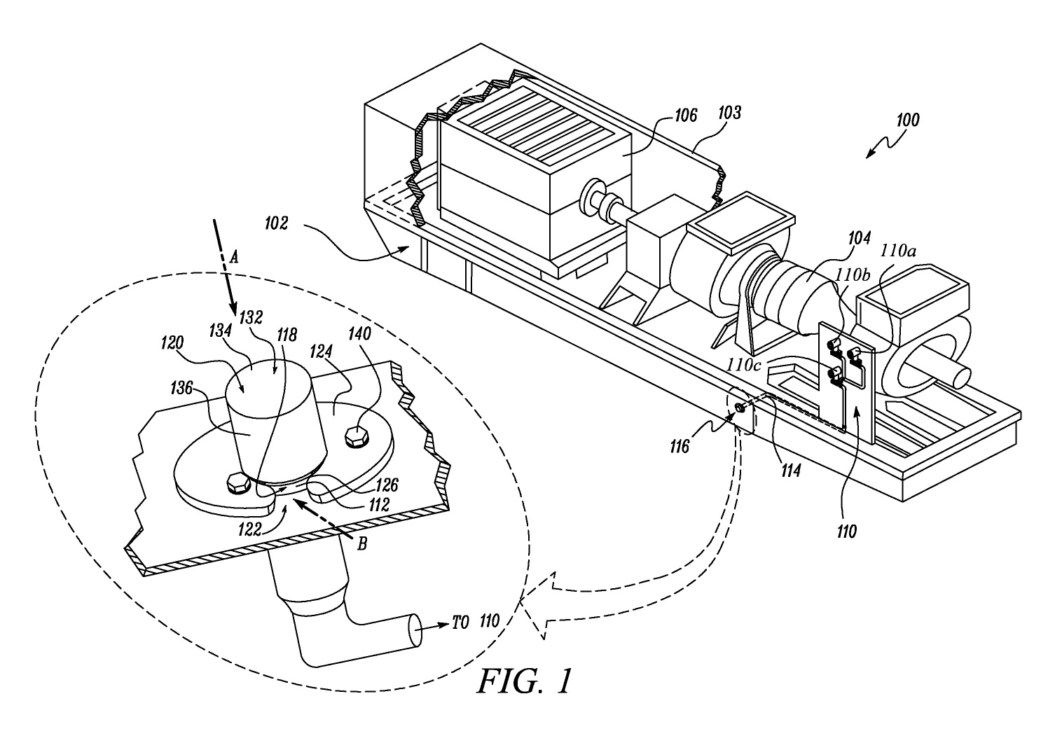

The present disclosure relates to a cover for a sensor port of a power system. FIG. 1 shows a breakaway perspective view of an exemplary power system 100 in which disclosed embodiments may be implemented. As shown in FIG. 1, the power system 100 includes a frame 102, and an enclosure 103. The enclosure 103 is configured to sit on the frame 102. The power system 100 may further include an engine 104, and a driven component 106 disposed on the frame 102. Therefore, the frame supports the enclosure 103, the engine 104, and the driven component 106 thereon. Further, as shown in FIG. 1, the engine 104 is disposed within the enclosure 103. Therefore, the enclosure 103 encloses or surrounds the engine 104. Further, as shown in FIG. 1, the enclosure 103 may also be additionally configured to surround the driven equipment 106.

The engine 104, disclosed herein, may be coupled to the driven component 106 and configured to drive the driven component 106. The engine 104 may be, for example, a gas turbine engine (as shown), a reciprocating engine, or other type of engine. The driven component 106 may be, for example, a generator (as shown), a compressor, or any other type of driven equipment.

The power system 100 may further include at least one pressure sensor 110 disposed within the enclosure 103. The pressure sensors 110 may be associated with the engine 104, the driven component 106, and the enclosure 103. In an exemplary embodiment as shown in FIG. 1, three pressure sensors 110, namely—a first pressure sensor 110a, a second pressure sensor 110b, and a third pressure sensor 110c, are shown disposed within the enclosure 103.

The first pressure sensor 110a may be associated with the driven equipment 106, for example, to measure fluid pressure at an inlet of the compressor. The second pressure sensor 110b may be associated with a tank (not shown) of the power system 100, for example, a fuel tank used to supply fuel to the engine 104. The second pressure sensor 110b may be configured to measure fluid pressure of liquid or gaseous fuel in the tank. The third pressure sensor 110c may provide measurement of ambient pressure conditions present within the power system 100.

Although three pressure sensors 110 are disclosed herein, it is to be noted a number of pressure sensors 110 included in the power system 100 is merely exemplary in nature and hence, non-limiting of this disclosure. Therefore, any number of pressure sensors 110 may be provided to measure fluid pressure at different locations of the power system 100 depending on specific requirements of an application.

The pressure sensors 110 disclosed herein may be of a type known in the art. For example, the pressure sensors 110 may be pressure transmitters. Such pressure sensors 110 may be configured to obtain a reference value of atmospheric pressure and provide measurement of the respective fluid pressures relative to the reference value of atmospheric pressure.

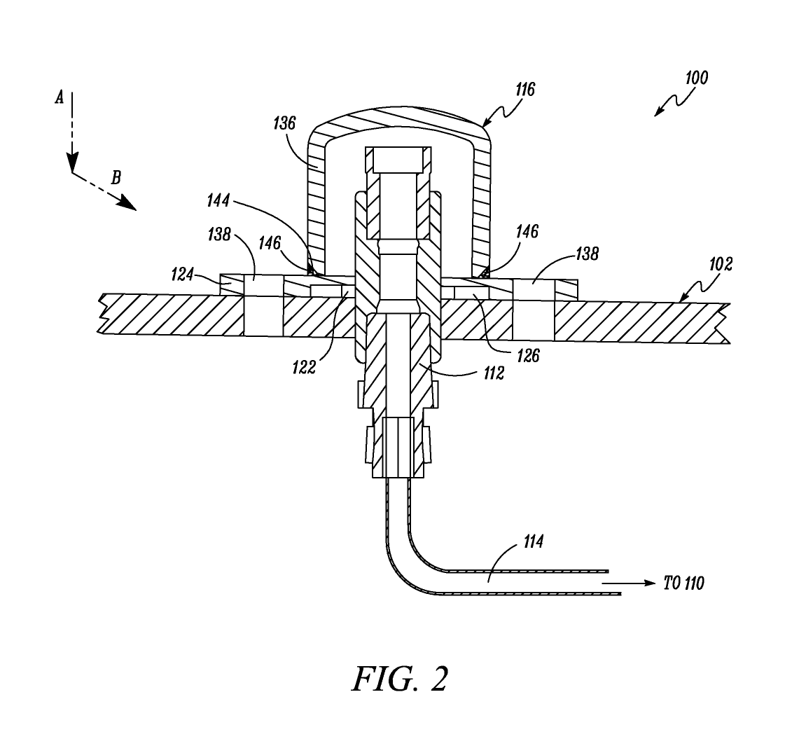

Accordingly, the power system 100 may include a sensor port 112 disposed in fluid communication with the pressure sensors 110. Referring to FIG. 2, the sensor port 112 may be located on the frame 102 and connected to the pressure sensors 110 by one or more tubing lines 114 coupled therebetween. The tubing lines 114, disclosed herein may be made of a material and construction configured to offer little or no resistance to airflow therein. For example, in one embodiment, the tubing lines 114 may be made from stainless steel material and constructed to include a seamless configuration. However, in other embodiments, other materials, and constructions may be employed to form the tubing lines 114 depending on specific requirements of an application.

In an exemplary embodiment as shown in FIG. 1, the sensor port 112 is circular in shape. However, in alternative embodiments, the sensor port 112 may be other shapes commonly known in the art. For example, the shape of the sensor port 112 may be, but is not limited to, a square shape, a rectangular shape, or an elliptical shape.

In an embodiment of the present disclosure as shown in FIGS. 1-2, the power system 100 further includes a cover 116 disposed on the sensor port 112. The cover 116 defines a passage 122 therein. The passage 122 is located proximate to the sensor port 112 and disposed laterally with respect to the sensor port 112. The passage 122 is configured to allow fluid communication of the sensor port 112 with an atmosphere. Therefore, the passage 122 may guide air laterally into the sensor port 112 and allow the laterally guided air to enter the tubing lines 114. Thereafter, the pressure sensors 110 may obtain the reference value of atmospheric pressure from the laterally guided air and provide measurement of various fluid pressures relative to the obtained reference value of atmospheric pressure.

In an embodiment as shown in FIG. 1, the cover 116 further includes an open end 118 and a closed end 120. The open end 118 is disposed proximal to the sensor port 112. The closed end 120 is disposed in opposing relation to the open end 118. The passage 122 may be laterally defined between the closed end 120 and the open end 118. The passage 122 lies proximate to the open end 118 and is hence, located proximally with respect to the sensor port 112. The proximity of the passage 122 with respect to the open end 118 and the sensor port 112 may allow air to be laterally deflected and guided into the sensor port 112.

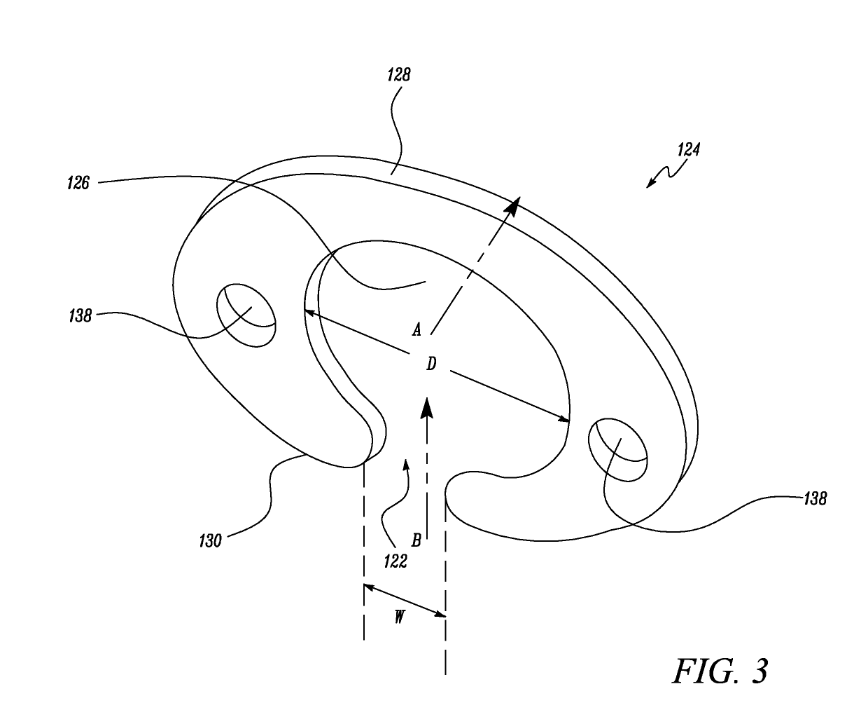

In the exemplary embodiment as shown in FIGS. 1-2, the cover 116 may include a base plate 124 positioned on the frame 102. The base plate 124 defines an opening 126 therethrough (see FIG. 3). The opening 126 of the base plate 124 may be axially disposed with the sensor port 112. The base plate 124 together with the opening 126 disclosed herein may be configured to structurally define the open end 118 of the present disclosure.

With continued reference to the exemplary embodiment of FIG. 3, the passage 122 may be located on the base plate 124. The passage 122 may extend from the opening 126 to a periphery 128 of the base plate 124. Therefore, the passage 122 may be disposed to fluidly communicate air from the atmosphere into the sensor port 112 via the opening 126 on the base plate 124.

Further, as shown in the embodiment of FIG. 3, the passage 122 may extend into a bottom side 130 of the base plate 124. During assembly of the cover 116 onto the sensor port 112, the bottom side 130 of the base plate 124 is configured to be disposed towards a ground surface on which the power system 100 is mounted (see FIG. 1). Consequently, upon assembly of the cover 116, the passage 122 may be disposed lower than the opening 126 and the sensor port 112 and hence, configured to guide air upwardly towards the opening 126 i.e. along lateral direction B. Thereafter, the air at the opening 126 may proceed in an axial direction A to enter the sensor port 112 and allow the pressure sensors 110 to obtain the reference value of atmospheric pressure therefrom.

As shown in the embodiment of FIGS. 1-2, the cover 116 may further include a shroud 132 disposed on the base plate 124. The shroud 132 is configured to enclose the opening 126 such that air from the atmosphere is prevented from directly entering the sensor port 112 in the axial direction A. The shroud 132 may include a top wall 134, and a peripheral wall 136. As shown in FIGS. 1-2, the top wall 134 is spaced apart and disposed above the opening 126 of the base plate 124. In an embodiment, the top wall 134 disclosed herein may be configured to structurally define the closed end 120 of the present disclosure. The peripheral wall 136 may depend downwardly from the top wall 134 of the shroud 132 and rigidly attach with the base plate 124.

In an embodiment of the present disclosure as shown in FIG. 3, a width W of the passage 122 is lesser than a diameter D of the sensor port 112. The width W of the passage 122 may be in a range of 20% to 70% of the diameter D of the sensor port 112. In one embodiment, the width W may be 25% of the diameter D. In another embodiment, the width W may be 50% of the diameter D. In yet another embodiment, the width W may be 70% of the diameter D.

Although the term “diameter” has been disclosed herein, the term “diameter” is used to aid the reader's understanding of the present disclosure and hence, is to be in the explanatory sense with reference to the present disclosure. The term “diameter” is a word of expression and its scope may extend to include other words of expression typically used to denote dimensions such as, but not limited to, length, width, breadth, height, or area. In various embodiments of the present disclosure, the diameter D may represent the largest dimension and/or size of the sensor port 112 measured in a plane of the sensor port 112.

In an example, if an area of the sensor port 112 is changed from 25 square centimeters to 60 square centimeters, a width W of the passage 122 may be changed suitably in the aforesaid range, i.e. 20% to 70% of 60 square centimeters so that the width W of the passage 122 may suitably correspond with the size of the sensor port 112. Therefore, it is envisioned to define the passage 122 such that a size of the passage 122 is comparable to the size of the opening 126.

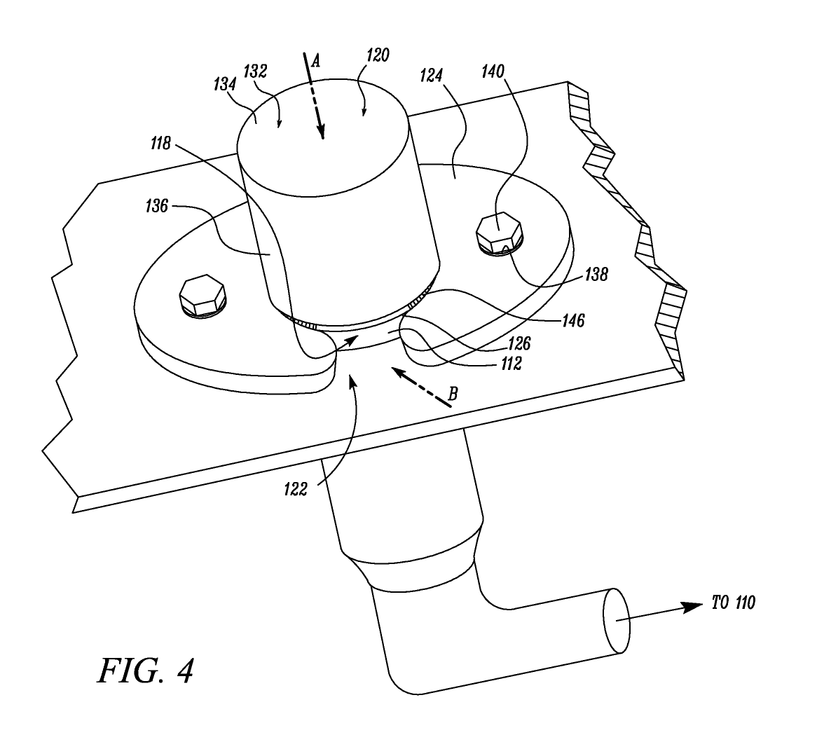

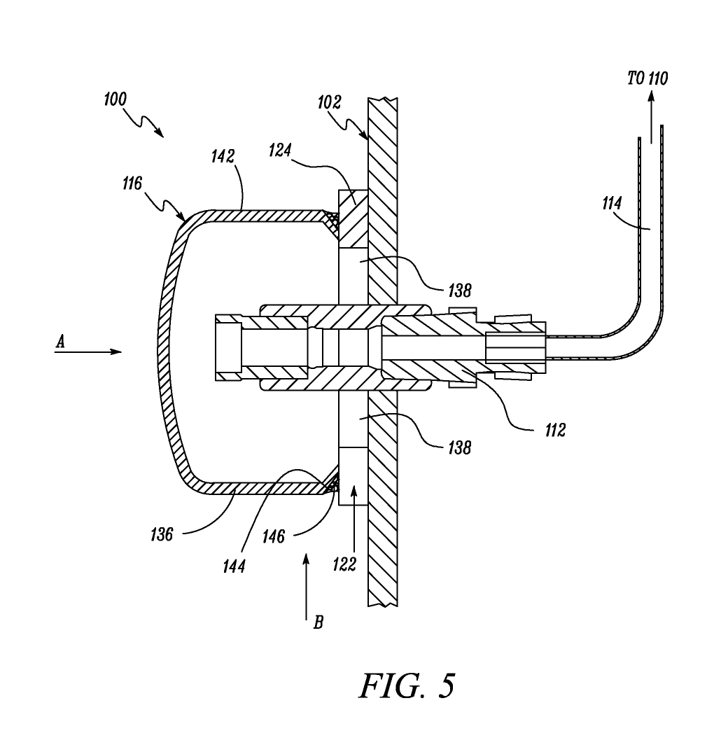

FIGS. 4-5 illustrate exemplary embodiments of the cover 116 configured for fitment and operation with the sensor port 112. Although an elliptical base plate 124, a circular opening 126, and a circular sensor port 112 are shown in FIGS. 1 and 3, it is to be noted that the shapes of the base plate 124, the opening 126, and the sensor port 112 are merely exemplary in nature and hence, non-limiting of this disclosure. The shapes of the base plate 124, the opening 126, and the sensor port 112 may be suitably selected depending on specific requirements of an application. Some shapes that can be used to define the base plate 124, the opening 126, and the sensor port 112 may be, for example, square, rectangular, elliptical, and other polygonal or irregular shapes commonly known in the art.

The base plate 124 may be coupled to the frame 102 of the power system 100 by various methods, for example, bolting, welding, brazing, soldering, or riveting. As shown in the exemplary embodiment of FIG. 4, the base plate 124 may be configured to releasably couple with the frame 102 by bolting or fastening. The base plate 124 may include holes 138 configured to correspond with one or more holes (not shown) of the frame 102. The holes 138 of the base plate 124 together with the holes of the frame 102 may receive fasteners 140 therein such that the fasteners 140 releasably couple the base plate 124 to the frame 102. The fasteners 140 may include, for example, threaded fasteners, rivets, or other fasteners commonly known in the art to accomplish a releasable engagement between two components.

In an aspect of the present disclosure, it may be envisioned to size the base plate 124 depending upon a type of coupling between the base plate 124 and the frame 102 i.e. the base plate 124 may be configured to be larger or smaller than the sensor port 112 depending on the type of coupling between the base plate 124 and the frame 102. For example, if the base plate 124 is coupled to the frame 102 by bolting or riveting, it may be helpful to increase the size of the base plate 124 and provide space for the holes 138 therein.

However, if the base plate 124 is coupled to the frame 102 by welding, soldering, or brazing, the base plate 124 may be larger or smaller than the sensor port 112 depending on a technique of welding, brazing, or soldering adopted therein. For example, the base plate 124 may be lap-welded to the frame 102 thus requiring a larger base plate 124 to be used or by butt-welding where a smaller base plate 124 can be used.

Further, as shown in FIG. 5, an outer surface 142 of the peripheral wall 136 may be rigidly attached to the base plate 124. The rigid attachment of the peripheral wall 136 to the base plate 124 may be accomplished by means of welding.

Furthermore, in an exemplary embodiment as shown in FIG. 5, the peripheral wall 136 may define a beveled end 144 disposed adjacent to the outer surface 142. The beveled end 144 may be welded to the base plate 124. Moreover, the beveled end 144 may allow the weld to be flush with the outer surface 142 of the peripheral wall 136.

Although it is disclosed herein that the shroud 132 is welded to the base plate 124, it is to be noted that the shroud 132 and the base plate 124 of the present disclosure may be associated or coupled to each other using any method known in the art. Therefore, methods of associating the shroud 132 to the base plate 124 are merely exemplary in nature and hence, non-limiting of this disclosure.

In various embodiments of the present disclosure, the base plate 124 and the shroud 132 may be integrally formed to impart a unitary construction to the cover 116. Therefore, a person having ordinary skill in the art will acknowledge that numerous configurations of the cover 116 may be used for laterally orienting the passage 122 with respect to the sensor port 112. Accordingly, various methods for forming the same may be suitably adopted without deviating from the scope of the present disclosure.

### INDUSTRIAL APPLICABILITY

Explanations pertaining to the working of the cover 116 will be made with reference to directions A and B, where the direction A is co-axial to the sensor port 112 while the direction B is laterally oriented with respect to the sensor port 112.

Referring to FIGS. 1-3, during operation of the power system 100, the pressure sensors 110 may be configured to obtain a reference value of the atmospheric pressure from air entering the sensor port 112. The shroud 132 restricts the direct entry of air across the top wall 134 and into the sensor port 112, i.e., air travelling along the direction A is prevented from directly entering the sensor port 112. However, air travelling along the direction B is allowed to enter the sensor port 112 via the passage 122, i.e., the air travelling along the axis B is laterally directed from the passage 122 to the sensor port 112. Consequently, atmospheric pressure recorded at the pressure sensors 110 may be based on the airflow laterally entering from the passage 122, i.e., along the direction B, into the sensor port 112.

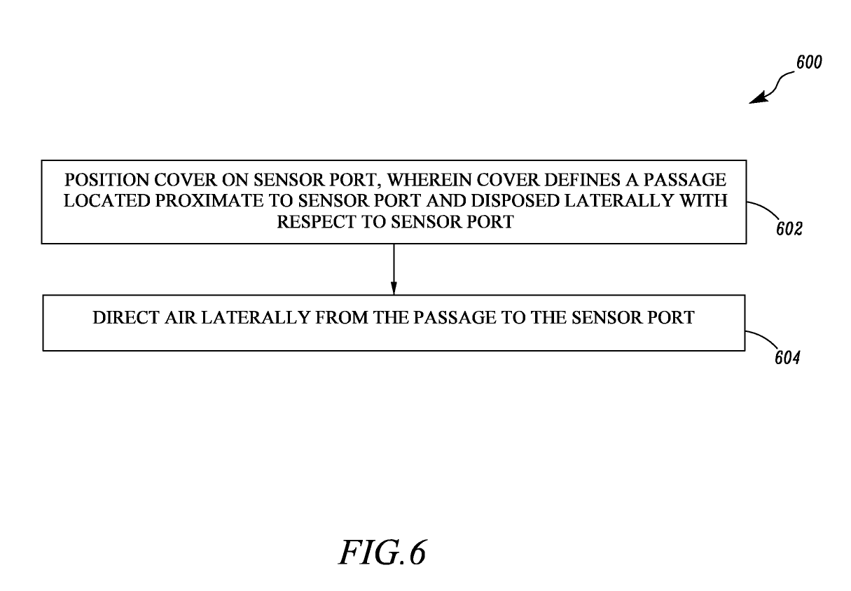

FIG. 6 shows a method 600 of allowing fluid communication between the sensor port 112 and the atmosphere. At step 602, the method 600 includes positioning the cover 116 on the sensor port 112. The cover 116 disclosed herein is configured to define the passage 122 disposed laterally with respect to the sensor port 112 and located proximate to the sensor port 112. At step 604, the method 600 further includes directing air laterally from the passage 122 to the sensor port 112

In an embodiment, the method 600 additionally includes restricting an axial entry of air into the sensor port 112 by the cover 116, i.e., air travelling along the direction A is prevented from flowing across the closed end 120 of the cover 116 and directly entering the sensor port 112.

Enclosures may employ one or more pressure sensors 110 to measure fluid pressures at various locations in the enclosure. Typically, these pressure sensors may obtain a reference value of atmospheric pressure from a sensor port on the enclosure and measure the fluid pressure relative to the reference value of atmospheric pressure.

However, atmospheric pressure in the vicinity of the sensor port may change due to localized changes occurring in conditions near the enclosure. Any increase in the atmospheric pressure in the vicinity of the sensor port due to, for example, crosswinds occurring near the enclosure, operation of an aerial vehicle (E.g., a helicopter), or the presence of a hurricane, may lead to a large amount of airflow being forced axially into the sensor port.

Consequently, in the absence of the cover 116, the pressure sensors may record a higher reference value of atmospheric pressure or a reference value that is biased due to the changes occurring near the enclosures. Therefore, the bias in the reference value of atmospheric pressure may cause the pressure sensors to provide incorrect measurement and values of fluid pressures. In some cases, the biased values may lead to incorrect monitoring of a machine disposed within the enclosure. In other cases, the biased values may be indicative of unfavorable conditions and may trigger a shutdown of the machine.

The cover 116 of the present disclosure helps to minimize bias in measurement of the fluid pressures by the pressure sensors 110. Use of the cover 116 may reduce the possibility of bias while obtaining the reference value of atmospheric pressure. The closed end 120 of the cover 116, for example, the top wall 134 of the shroud 132, restricts the axial entry of air across the cover 116 and into the sensor port 112, i.e., direct entry of air from the atmosphere into the sensor port 112 along axis A. Instead, the cover 116 laterally directs the air from the passage 122 to the sensor port 112 i.e. allowing air along direction B to enter the sensor port 112. Therefore, with use of the cover 116 disclosed herein, external factors such as gusts of wind, high local atmospheric pressure due to operation of an aerial vehicle, or the presence of a hurricane, are prevented from influencing the reference value of atmospheric pressure at the sensor port 112.

Consequently, with implementation of the cover 116, the value of atmospheric pressure obtained at the pressure sensors 110 may not be biased by the localized changes occurring near the power system 100. The pressure sensors 110 may measure various fluid pressures relative to the reference value of atmospheric pressure and allow correct monitoring of the power system 100. In some cases, the use of the cover 116 with the sensor port 112 may prevent the pressure sensors 110 from triggering false alarms or causing shutdown of the machine due to the changes occurring in conditions near the power system 100.

While aspects of the present disclosure have been particularly shown and described with reference to the embodiments above, it will be understood by those skilled in the art that various additional embodiments may be contemplated by the modification of the disclosed machine, systems and methods without departing from the spirit and scope of what is disclosed. Such embodiments should be understood to fall within the scope of the present disclosure as determined based upon the claims and any equivalents thereof.

I claim:

1. A power system comprising:
a frame;
an enclosure disposed on the frame;
an engine disposed within the enclosure;
at least one pressure sensor disposed within the enclosure and associated with the engine;
a sensor port located on the frame and disposed in fluid communication with the at least one pressure sensor; and
a cover disposed on the sensor port, the cover defining a passage disposed laterally with respect to the sensor port, wherein the passage is located proximate to the sensor port and configured to allow fluid communication of the sensor port with atmosphere.

2. The power system of claim 1, wherein the cover includes:
a base plate positioned on the sensor port, the base plate defining an opening therethrough, the opening disposed axially with the sensor port; and
a shroud disposed on the base plate, the shroud configured to enclose the opening.

3. The power system of claim 2, wherein the shroud comprises:
a top wall spaced apart and disposed above the opening; and
a peripheral wall depending downwardly from the top wall, the peripheral wall configured to be rigidly attached to the base plate.

4. The power system of claim 2, wherein the passage extends from the opening to a periphery of the base plate.

5. The power system of claim 4, wherein the passage extends into a bottom side of the base plate and is disposed lower than the opening, and wherein the passage is configured to guide airflow upwardly towards the opening.

6. The power system of claim 1, wherein a width of the passage is lesser than a diameter of the sensor port.

7. The power system of claim 6, wherein the width of the passage is in a range of 20% to 70% of the diameter of the sensor port.

8. A cover for a sensor port, the cover comprising:
an open end disposed proximal to the sensor port;
a closed end disposed in opposing relation to the open end; and
a passage laterally defined between the open end and the closed end, the passage disposed proximal to the open end and configured to allow fluid communication of the sensor port with atmosphere.

9. The cover of claim 8, wherein the cover includes:
a base plate positioned on the sensor port, the base plate defining an opening therethrough, the opening disposed axially with the sensor port; and
a shroud disposed on the base plate, the shroud configured to enclose the opening.

10. The cover of claim 9, wherein the shroud comprises:
a top wall spaced apart and disposed above the opening; and
a peripheral wall depending downwardly from the top wall, the peripheral wall configured to be rigidly attached to the base plate.

11. The cover of claim 9, wherein the passage extends from the opening to a periphery of the base plate.

12. The cover of claim 11, wherein the passage extends into a bottom side of the base plate and is disposed lower than the opening, and wherein the passage is configured to guide airflow upwardly towards the opening.

13. The cover of claim 8, wherein a width of the passage is lesser than a diameter of the sensor port.

14. The cover of claim 13, wherein the width of the passage is in a range of 20% to 70% of the diameter of the sensor port.

15. A method of allowing fluid communication between a sensor port and atmosphere, the method comprising:
positioning a cover on the sensor port, wherein the cover defines a passage located proximate to the sensor port and disposed laterally with respect to the sensor port; and
directing air laterally from the passage to the sensor port.

16. The method of claim 15, wherein the method further comprises restricting an axial entry of air into the sensor port by the cover.

17. The method of claim 15, wherein the method includes:
providing the cover with a base plate and an opening defined therethrough, the opening disposed axially with respect to the sensor port; and
positioning a shroud on the base plate to enclose the opening.

18. The method of claim 16, wherein the passage extends from the opening to a periphery of the base plate.

19. The method of claim 17, wherein the passage extends into a bottom side of the base plate and is disposed lower than the opening, and wherein the passage is configured to guide airflow upwardly towards the opening.

20. A power system including:
a frame;
an enclosure disposed on the frame;
an engine disposed within the enclosure;
at least one pressure sensor disposed within the enclosure and associated with the engine;
at least one sensor port located on the frame and disposed in fluid communication with the at least one pressure sensor; and
employing the method of claim 15 to fluidly communicate the sensor port and atmosphere.
